(19) United States
(12) Patent Application Publication
(10) Pub. No.: US 2020/0163179 A1
(43) Pub. Date: May 21, 2020

(54) LIGHTING DEVICE

(71) Applicant: DELTA ELECTRONICS, INC., Taoyuan City (TW)

(72) Inventors: Cheng-Chieh OU, Taoyuan City (TW); Chang-Tai CHEN, Taoyuan City (TW); Cheng-Yi LO, Taoyuan City (TW)

(21) Appl. No.: 16/378,586

(22) Filed: Apr. 9, 2019

(30) Foreign Application Priority Data
Nov. 21, 2018 (CN) 201811391681.3

(51) Int. Cl. H05B 37/02; H02S 99/00

(52) U.S. Cl. CPC H05B 37/0272; H02S 99/00

(57) ABSTRACT

A lighting device includes a controller, a memory and a wireless communicator. The controller is coupled to the wireless communicator and configured to control an emitting element according to a wireless data signal. The memory is coupled to the controller and configured to store the wireless data signal. The wireless communicator includes a wireless transceiver element and a solar cell. The wireless transceiver element is configured to receive the wireless data signal. The solar cell is configured to receive visible light and convert visible light into electric power to supply to the controller, the memory, the wireless transceiver element or the emitting element.

### RELATED APPLICATIONS

This application claims priority to China Application Serial Number 201811391681.3, filed Nov. 21, 2018, which is herein incorporated by reference.

### BACKGROUND

### Technical Field

The disclosure relates to a lighting device, particularly to a programmable lighting device.

### Description of Related Art

With the development of technology, the demand for lighting is increasing, the application of light emitting diodes (LEDs) is more and more extensive, and the operation of LEDs usually needs to be adjusted to adapt to different needs.

Therefore, how to improve the adaptability of the operation of LEDs conveniently and efficiently is one of the important issues in the field.

### SUMMARY

One aspect of the present disclosure is a lighting device including a controller, a memory and a wireless communicator. The controller is coupled to the wireless communicator and configured to control an emitting element according to a wireless data signal. The memory is coupled to the controller and configured to store at least a data signal. The wireless communicator includes a wireless transceiver element and a solar cell. The wireless transceiver element is configured to receive the wireless data signal. The solar cell is configured to receive visible light and convert visible light into electric power to supply to the controller, the memory, the wireless transceiver element or the emitting element.

Another aspect of the present disclosure is a lighting device including a shell, a light transmission layer, a controller, a memory, a wireless communicator and a solar cell. The shell is formed with a slot hold. The light transmission layer is arranged in the slot hold. The controller is configured to control an emitting element according to a wireless data signal. The memory is coupled to the controller and configured to store at least a data signal. The wireless communicator is arranged in the shell and adjacent to the light transmission layer, and configured to receive a visible light and convert the visible light into an electric power to supply to the controller, the memory, a wireless transceiver element or the emitting element.

### BRIEF DESCRIPTION OF THE DRAWINGS

FIG. 1 is a schematic diagram illustrating a lighting device in accordance with some embodiments of the disclosure.

FIG. 2 is a schematic diagram illustrating combination of a lighting device in accordance with some embodiments of the disclosure.

FIG. 3 is a schematic diagram illustrating a section of a wireless communicator along line A-A′ in accordance with embodiment of FIG. 2

FIG. 4 is a schematic diagram illustrating signals transmission of a lighting device in accordance with some embodiments of the disclosure.

FIG. 5 is a block diagram illustrating of function of a lighting device and an electrical device in accordance with some embodiments of the disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

In the following description and in the claims, the terms “include” and “comprise” are used in an open-ended fashion, and thus should be interpreted to mean “include, but not limited to.” As used herein, the term “and/or” includes any and all combinations of one or more of the associated listed items.

In this document, the term “coupled” may also be termed “electrically coupled,” and the term “connected” may be termed “electrically connected.” “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

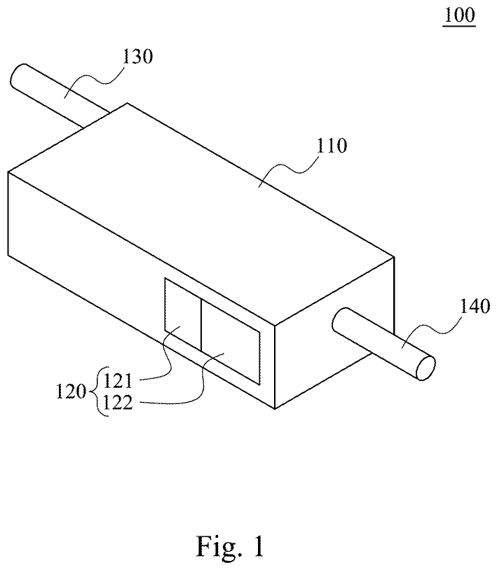

Please refer to FIG. 1. FIG. 1 is a schematic diagram illustrating a lighting device 100 in accordance with some embodiments of the disclosure. A plurality of embodiments will be disclosed with diagrams in the following, for clarity of explanations, lots of details in practical are described in the following as well. However, it should be noted that the details in practical will not be limited to the disclosure. That is, in some embodiments in the disclosure, some details in practical are not necessary. In addition, to simplify the schema diagrams, some conventional structures and elements will be illustrated in a simplified schematic manner.

As shown in FIG. 1, the lighting device 100 includes a shell 110, a wireless communicator 120, an AC power line 130 and an output terminal 140. The wireless communicator 120 includes a wireless transceiver element 121 and a solar cell 122.

In some embodiments, the lighting device 100 is connected to an external AC power (e.g., supply mains) through the AC power line 130. The lighting device 100 is connected to an emitting element (e.g., light emitting diodes) through the output terminal 140.

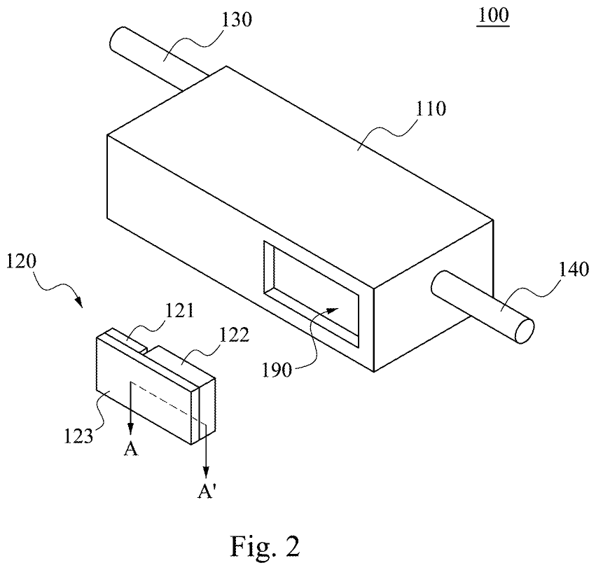

Please refer to FIG. 2. FIG. 2 is a schematic diagram illustrating combination of a lighting device 100 in accordance with some embodiments of the disclosure. As shown in FIG. 2, in the embodiments of FIG. 2, elements similar to those in the embodiments of FIG. 1 are denoted by the same labels. In some embodiments, the wireless communicator 120 includes a light transmission layer 123. As shown in FIG. 2, in structure, the shell 110 is formed with a slot hold 190. The light transmission layer 123 is arranged in the slot hold 190 of shell 110. The wireless transceiver element 121 and the solar cell 122 are arranged in the shell 110 and adjacent to the light transmission layer 123.

Specifically, in some embodiments, the wireless transceiver element 121 is aligned to the light transmission layer 123, and the wireless transceiver element 121 is configured to receive a wireless data signal from the outside of the shell 110 through the light transmission layer 123 from the slot hold 190. In some embodiments, the solar cell 122 is adjacent to the light transmission layer 123, and the solar cell 122 is configured to receive a visible light from the outside of the shell 110 through light transmission layer 123 from the slot hold 190.

When the shell 110 of the lighting device 100 is metal material or opaque material, the solar cell 122 is not able to receive the visible light to generate electric power. Similarly, the wireless data signal received and sent by the wireless transceiver element 121 may not be working properly cause the shielding of the metal material. Therefore, by arranging the light transmission layer 123 in the slot hold 190 on the shell 110, it will make the solar cell 122 enable to receive the visible light, and the wireless transceiver element 121 enable to send and receive the wireless data signals.

Furthermore, a modular structure of the combination of the wireless transceiver element 121 and the solar cell 122 is able to simplify the design and assembly of the lighting device 100, so as to improve the convenience of manufacturing and assembly of products. The detailed structure is described as follows.

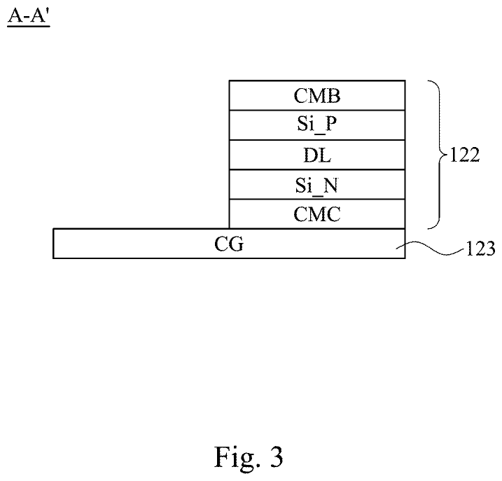

Please refer to FIG. 3. FIG. 3 is a schematic diagram illustrating a section of a wireless communicator 120 along line A-A′ in accordance with embodiment of FIG. 2. As shown in FIG. 3, the solar cell 122 is adjacent to the light transmission layer 123. In some embodiments, the light transmission layer 123 may be realized by cover glass CG, but not limited to the disclosure. The solar cell 122 includes a conductive metal base CMB, a silicon of P-type Si_P, a depletion layer DL, a silicon of N-type Si_N and a conductive metal contact CMC. The conductive metal contact CMC of the solar cell 122 is adjacent to the cover glass CG.

Specifically, the size of the solar cell 122 is based on the electric power required by the lighting device 100 and/or the emitting element, and/or the appearance (e.g., strip shape, wide flat shape) of the lighting device 100.

In some embodiments, the solar cell 122 provides power required by the controller 150, the wireless transceiver element 121 and memory 160. The output power of the solar cell 122 is different by depending on types of wireless communication, the selected materials, and/or design manner of the controller 150. For example, the output voltage of the solar cell 122 may be about 3.3 volts, and the output current of the solar cell 122 may be about 5.0 mA, but not limited to the disclosure.

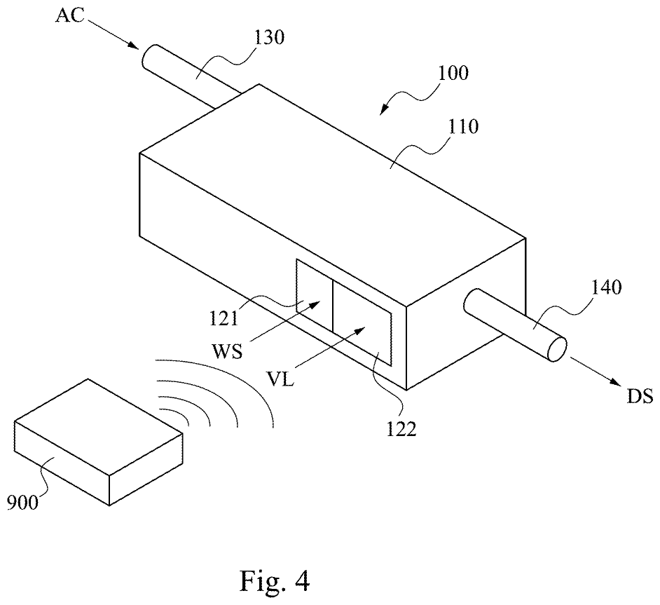

Please refer to FIG. 4. FIG. 4 is a schematic diagram illustrating signals transmission of a lighting device 100 in accordance with some embodiments of the disclosure. As shown in FIG. 4, in operation, the lighting device 100 transmits data to an electrical device 900 with the wireless data signals WS. Specifically, the solar cell 122 is configured to receive visible light VL and convert the visible light VL into electric power to supply to various components inside the lighting device 100 or the emitting element connected to the output terminal 140. The wireless transceiver element 121 is configured to receive and transmit the wireless data signals WS. The lighting device 100 outputs a driving signal DS to the emitting element (e.g. LED) by the output terminal 140.

Furthermore, in some embodiments, the lighting device 100 may receive external AC power (e.g. supply mains) through the AC power line 130 to provide electric power to various components inside the lighting device 100 or the emitting element connected to the output terminal 140.

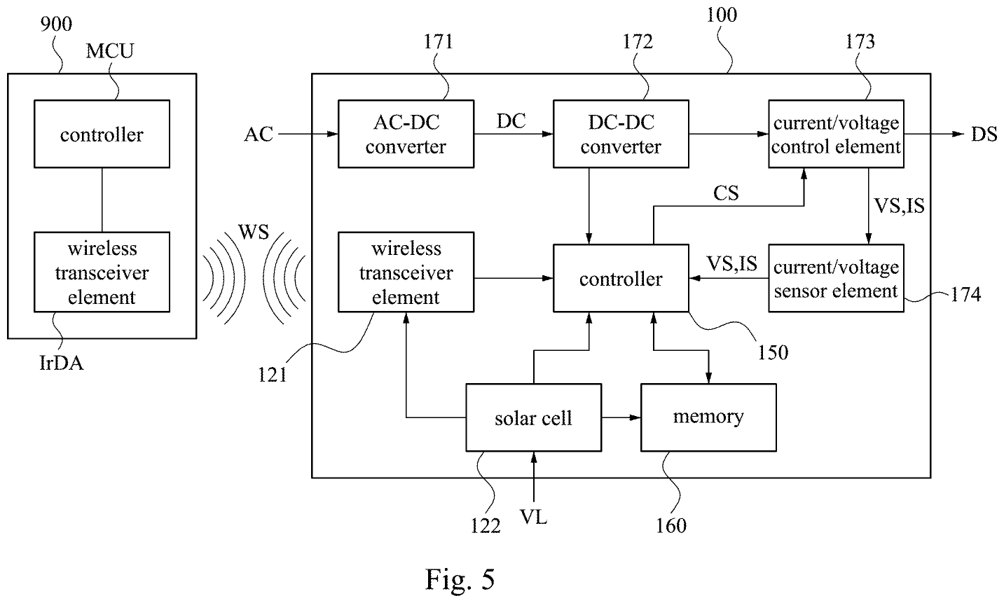

Specifically, please refer to FIG. 5. FIG. 5 is a block diagram illustrating of function of a lighting device 100 and an electrical device 900 in accordance with some embodiments of the disclosure. As shown in FIG. 5, the lighting device 100 includes the controller 150, the memory 160, the wireless transceiver element 121, the solar cell 122, an AC-DC converter 171, a DC-DC converter 172, a current/voltage control element 173 and a current/voltage sensor element 174. The electrical device 900 includes a controller MCU and wireless transceiver element IrDA.

In structure, the controller 150, the wireless transceiver element 121, the solar cell 122 and the memory 160 of the lighting device 100 are in the shell 110. The controller 150 of the lighting device 100 is coupled to the wireless transceiver element 121, the solar cell 122, the memory 160, the DC-DC converter 172, the current/voltage control element 173 and the current/voltage sensor element 174. The AC-DC converter 171 is coupled to the AC power line 130 and the DC-DC converter 172. The DC-DC converter 172 is coupled to the current/voltage control element 173. The current/voltage control element 173 is coupled to the current/voltage sensor element 174 and output terminal 140. The solar cell 122 is coupled to the wireless transceiver element 121, the controller 150 and the memory 160.

For example, the controller 150 may be realized by various circuits, digital signal processor (DSP), complex programmable logic device (CPLD), field-programmable gate array (FPGA), etc.

It should be noted that though the lighting device 100 of FIG. 5 includes independent controller 150, the wireless transceiver element 121 and the memory 160, that is, the wireless transceiver element 121 and the memory 160 is external to the controller 150, in some other embodiments, the wireless transceiver element 121 and/or the memory 160 may also be built-in the controller 150, not to limited to the disclosure.

In operation, the lighting device 100 transmits data to the electrical device 900 by the wireless data signal WS. The wireless transceiver element 121 of the lighting device 100 is configured to receive the wireless data signal WS and transmits the wireless data signal WS to the controller 150. The memory 160 of the lighting device 100 is configured to store at least one data signal. The data signals may include various information about the products, such as the protection times, protection types, input current, output current, input voltage, output voltage, and wireless data signal WS. The controller 150 of the lighting device 100 is configured to control the emitting element according to the data signal and/or the wireless data signal WS to control the emitting element.

Specifically, in some embodiments, the wireless data signal WS is infrared light. The wireless transceiver element 121 may be realized by an infrared data association (IrDA) device. In some other embodiments, the wireless transceiver element 121 may be realized by a radio frequency (RF) device, a Bluetooth device, a near-field communication (NFC) device, ANT device or ZigBee device, etc.

For example, the electrical device 900 with the wireless transceiver element IrDA sends the wireless data signal WS to the wireless transceiver element 121. The electrical device 900 with the wireless transceiver element IrDA may be a notebook, a desktop, a server, a cell phone or a tablet, etc. It should be noted that, the description above is merely example, not limited to the disclosure.

In addition, the wireless transceiver element 121 receives the wireless data signal WS of infrared light and converts the wireless data signal WS into the digital signal to send to the controller 150. The wavelength of infrared light is 750 nm-1500 nm, the frequency of infrared light is 399.72 THz-199.86 THz.

In some embodiments, the wireless data signal WS includes configure signals and/or control signals used in the emitting element connected to the lighting device 100, and/or configure signals and/or control signals used in the controller 150 of the lighting device 100.

For the convenience and clarity of explanation, following the wireless data signal WS is merely example, not limited to the disclosure, various alterations and modifications may be performed on the disclosure by those of ordinary skilled in the art without departing from the principle and spirit of the disclosure. The wireless data signal WS includes operating parameters used in initializing setting of the controller 150 of the lighting device 100. The wireless data signal WS includes signals used to set the upper and lower limits of output current or output voltage outputted from the lighting device 100 to the emitting element, and/or operation instructions to increase or decrease the output current or the output voltage. The wireless data signal WS includes operating parameters for controlling the emitting element to turn-off and/or turn-on. And the wireless data signal WS includes various parameter thresholds and termination command for warning the damage of the emitting element.

The controller 150 receives the wireless data signal WS from the wireless transceiver element 121 and stores the wireless data signal WS for controlling the emitting element and/or driving the emitting element to the memory 160. In some embodiments, the controller 150 output the control signal CS to current/voltage control element 173 according to the wireless data signal WS received from the wireless transceiver element 121. In some other embodiments, the controller 150 outputs the control signal CS to the current/voltage control element 173 according to data stored in the memory 160.

The current/voltage control element 173 is configured to adjust current and/or voltage according to the control signal CS sent from the controller 150, generate and output the driving signal DS to the emitting element through the output terminal 140. Furthermore, in some embodiments, the current/voltage sensor element 174 is configured to detect current and/or voltage of the current/voltage control element 173 to obtain current/voltage detecting signals VS, IS and output the current/voltage detecting signals VS, IS to the controller 150.

In this way. the controller 150 is able to perform feedback control by the current/voltage detecting signals VS, IS transmitted by the current/voltage sensor element 174, so as to dynamically adjust the control signal CS transmitted to the current/voltage control element 173.

Please keep referring to FIG. 5. As shown in FIG. 5, in some embodiments, the AC-DC converter 171 is configured to receive the external AC power from the AC power line 130, converts the external AC power into the DC power and sends the DC power to the DC-DC converter 172. The DC-DC converter 172 is configured to perform the adjustment of the current, voltage or other electric power parameters according to the DC power to supply to the controller 150 and the current/voltage control element 173.

In some embodiments, the solar cell 122 is configured to receive the visible light VL and converts the visible light VL into the electric power to supply to the controller 150, the memory 160, the wireless transceiver element 121 and/or the emitting element. The wavelength of the visible light VL is about 250 nm˜1100 nm, and the frequency of the visible light VL is about 119916.98 THz˜27253.86 THz.

In this way, in the embodiment, the lighting device 100 may operate by using the electric power generated by the solar cell 122 included by itself without external transmission lines. In addition, since the power generated by the solar cell 122 is DC power, it is not necessary to adjust the power parameters via the AC-DC converter, so that the components and circuits are able to be simplified and the cost is able to be reduced.

In the foregoing, exemplary operations are included. However, these operations do not need to be performed sequentially. The operations mentioned in the embodiment may be adjusted according to actual needs unless the order is specifically stated, and may even be performed simultaneously or partially simultaneously.

It is noted that, the drawings, the embodiments, and the features and circuits in the various embodiments may be combined with each other as long as no contradiction appears. The circuits illustrated in the drawings are merely examples and simplified for the simplicity and the ease of understanding, but not meant to limit the present disclosure. In addition, those skilled in the art can understand that in various embodiments, circuit units may be implemented by different types of analog or digital circuits or by different chips having integrated circuits. Components may also be integrated in a single chip having integrated circuits. The description above is merely by examples and not meant to limit the present disclosure.

In summary, in various embodiments of the present disclosure, the wireless transceiver element 121 makes the lighting device 100 easily adjusted for operating parameters, and the solar cell 122 makes the lighting device 100 enable to save more energy. Even without connected to AC power, the lighting device 100 is able to complete the data transmission and store the related parameters into the memory 160. Furthermore, the modular structure of the wireless communicator 120 combines the wireless transceiver element 121 and the solar cell 122, so as to simplify the design and assembly of the lighting device 100 and improve the convenience of manufacturing and assembly of products.

Although specific embodiments of the disclosure have been disclosed with reference to the above embodiments, these embodiments are not intended to limit the disclosure. Various alterations and modifications may be performed on the disclosure by those of ordinary skills in the art without departing from the principle and spirit of the disclosure. Thus, the protective scope of the disclosure shall be defined by the appended claims.

1. A lighting device, comprising:
a controller, configured to control an emitting element according to a wireless data signal;
a memory, coupled to the controller, configured to store at least a data signal; and
a wireless communicator, coupled to the controller, the wireless communicator comprising:
a wireless transceiver element, configured to receive the wireless data signal; and
a solar cell, configured to receive a visible light and convert the visible light into an electric power to supply to the controller, the memory, the wireless transceiver element or the emitting element;
a power control element, coupled to the controller, wherein the controller is configured to directly control the power control element that is configured to output a driving signal to the emitting element; and
a power sensor element, coupled to the controller, configured to detect the power control element to output a detecting signal, wherein the controller is configured to directly control the power control element in resonse to the detecting signal.

2. The lighting device of claim 1, wherein the wireless communicator further comprises a light transmission layer, the solar cell is adjacent to the light transmission layer, the wireless transceiver element is aligned to the light transmission layer.

3. The lighting device of claim 2, wherein the lighting device comprises a shell, the controller, the memory is in the shell, the shell comprises a slot hole, the light transmission layer is arranged in a slot hold.

4. The lighting device of claim 1, wherein the wireless data signal is infrared light.

5. The lighting device of claim 1, further comprising:
an AC-DC converter configured to convert an AC power to a DC power; and
a DC-DC converter configured to receive the DC power and to output a supply power for the controller.

6. (canceled)

7. The lighting device of claim 1, wherein the controller is configured to perform feedback control and to dynamically adjust the control signal according to the detecting signal.
